(19) United States
(12) Patent Application Publication
(10) Pub. No.: US 2019/0035225 A1
(43) Pub. Date: Jan. 31, 2019

(54) PRESENTATION OF VIDEO POKER GAME

(71) Applicant: Roger Kemper, Henderson, NV (US)

(72) Inventor: Roger Kemper, Henderson, NV (US)

(21) Appl. No.: 16/046,638

(22) Filed: Jul. 26, 2018

Related U.S. Application Data
(60) Provisional application No. 62/537,920, filed on Jul. 27, 2017.

(51) Int. Cl. G07F 17/32

(52) U.S. Cl. CPC G07F 17/3293; G07F 17/3227

(57) ABSTRACT

A presentation of cards in a video poker game is implemented in a way that makes the game more exciting and fun for players. A randomly dealt hand is ordered and ranked with respect to straights, flushes, combination of straights and flushes, and of-a-kind hands. The ranking of a hand determines how each card in the hand is presented to the player with respect to timing and audio between revealing each card. Depending on the hand, the time interval between revealing the second and third cards may be longer than the interval between the first two cards. The time interval between revealing the third and fourth cards may be longer than the previous interval. The interval for the last card may be the longest depending on the hand ranking. The timing is determined by software on the gaming machine or device and is intended to increase excitement for the player.

### CROSS-REFERENCE TO RELATED APPLICATIONS

This application claims the benefit under 35 U.S.C. § 119(e) of US Provisional Patent Application 62/537,920, entitled “SYSTEM AND METHOD FOR VIDEO POKER GAME EXECUTION AND PRESENTATION,” filed on Jul. 27, 2017, which is incorporated herein by reference in its entirety for all purposes.

### TECHNICAL FIELD

The present invention relates to wager gaming software and systems. More specifically, it relates to software and systems for implementing a user experience for playing video poker on a gaming machine or gaming device.

### BACKGROUND

Presently, video poker games do not take full advantage of their potential to provide a more exciting user experience. Video poker has been played in generally the same manner for decades. Other than offering different types of games with varying pay tables, the essential user playing experience has barely changed. In fact, empirical evidence shows that video poker is far less popular than slots, despite the fact that video poker often has significantly higher payouts. One implication from this is that slots has a level of excitement that compensates for the lower payouts, and that this excitement or entertainment component is clearly missing from video poker. This stagnation in the video poker arts is a result, at least in part, of an underlying technological problem. Specifically, the software and user interface for implementing and executing the video poker games are not designed, and certainly not engineered, to take fuller advantage of the excitement that video poker has to offer. This technological problem requires a software and user interface-centric solution. As such, it would be a technological advancement and general improvement in the field of wager gaming to make video poker a more exciting and memorable experience.

A solution to these engineering problems and deficiencies should address several factors while also avoiding certain pitfalls. For example, the user interface should be kept simple and easy for beginner players. A screen should not be confusing to a player; complexity would be a major deterrent. The user should experience a higher emotional investment in the game by having the game screens emphasize the potential or chance of having a hand that could result in a big payout. For example, the user can visually see on the screen how close she came to winning a large payout. The technological solution may include software and screen layouts that effect the order/arrangement and presentation of a hand of dealt cards. For example, drawn cards can be displayed in an order that shows the best hand the player has. In other words, the cards are not necessarily dealt, that is, displayed or presented to the player, in the order they were randomly drawn. More generally, a solution may include making it easier for a player to recognize a “big hand” and re-draw opportunities. The timing of showing redrawn cards can also be modified to increase excitement. That is, the timing of the “reveal” can vary depending on the dealt cards and, more generally, the pace of play can be designed to realize more excitement for the player. The visual display to the player can also be engineered to look like, for example, spinning wheels in a slot machine, and showing cards that were close to being re-drawn. All these features require software engineering solutions and, in some cases, an advancement in video poker screen presentation, which may include visual, audio, and temporal aspects.

### SUMMARY

In one aspect of the present invention, a method of displaying cards on a gaming device is described. A straight hand evaluator software module determines whether an ordered hand (e.g., from high to low card) has a gap in the sequence. A flush hand evaluator software module determines whether an ordered hand has a potential flush by examining the suit of each card in the hand. An of-a-kind hand evaluator software module determines whether the hand may be something other than a straight, flush, or combination by counting the number of each card type. By the end of the evaluations, a hand is assigned either one of various straight rankings, one of various flush rankings, or one of various of-a-kind rankings.

In another aspect of the present invention, a method of presenting five cards in a video poker game is described. A first card in the hand is displayed to the player after a first time interval. A second card is displayed after the same first time interval. A third card is displayed after a second time interval. A fourth card is displayed after a third time interval. The last card is displayed after a fourth time interval. The first time interval is generally the shortest. The second time interval is longer than the first interval. The third interval is equal to or longer than the second time interval. The fourth interval is equal to or longer than the third time interval. In other embodiments, audio clips may accompany the display or reveal of each card to increase excitement for the player.

### BRIEF DESCRIPTION OF THE DRAWINGS

FIGS. 1A to 1C is a series of screen shots showing how a hand of five cards may be drawn for and displayed or presented to a player in accordance with one embodiment;

FIG. 2 is a flow diagram of a process of executing a video poker game in accordance with one embodiment;

FIG. 3 is a flow diagram showing an overview of a process for evaluating a hand of cards and assigning a rank to the hand for presentation to a user on a gaming device in accordance with one embodiment;

FIG. 4 is a flow diagram of a process for evaluating a hand for a straight and assigning it a straight ranking in accordance with one embodiment;

FIG. 5 is a flow diagram of a process of assigning various flush rankings, including royal flush, straight flush rankings, and lower rank flushes to a hand in accordance with one embodiment; and

FIG. 6 is a flow diagram of a process of assigning ranks to a hand that is not a straight, flush, or combination in accordance with one embodiment.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

In conventional video poker one player plays against a gaming machine (operated by the house) which displays the player's cards on a screen. In one embodiment, the player places a bet and is dealt 5 cards from a standard 52 card deck. The player has one opportunity to discard any number of unwanted cards and is dealt an equal number of replacement cards from the same deck. If the player then has a sufficiently good poker hand, the house pays the player according to a fixed scale of odds according to the type of hand. The term “sufficiently good” often means, for example, a pair of Jacks or better. If the final hand is worse than the minimum qualifying winning hand as set for that specific game then the bet is lost to the house. The exact odds offered and the minimum winning hands vary from game to game.

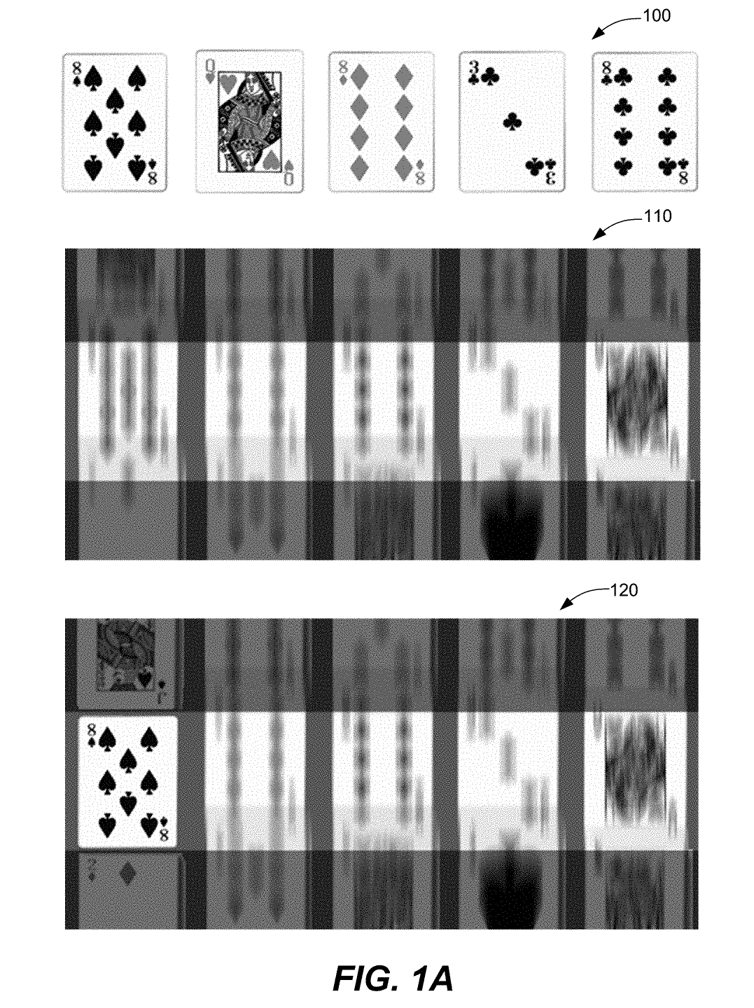

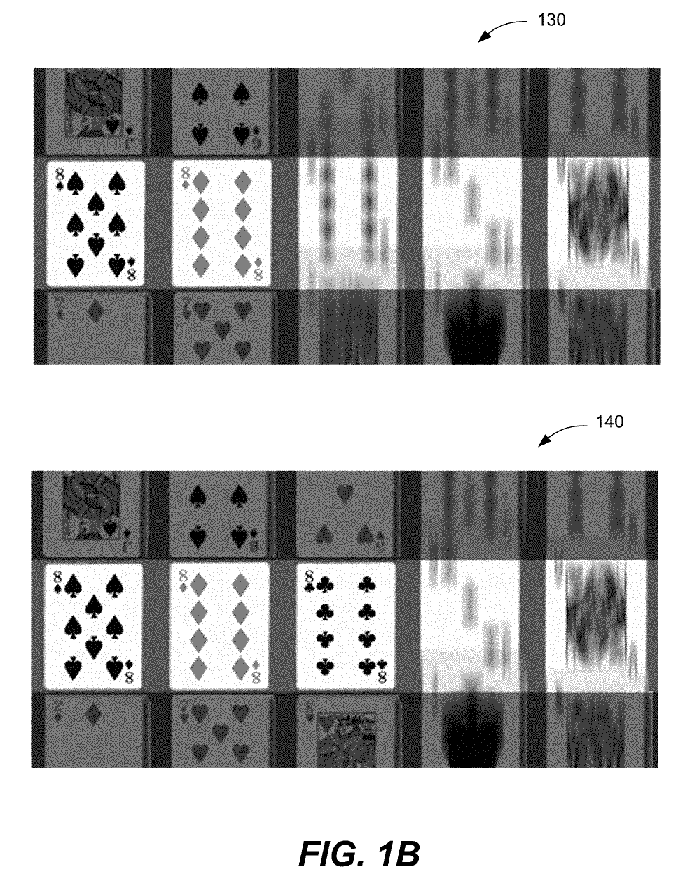

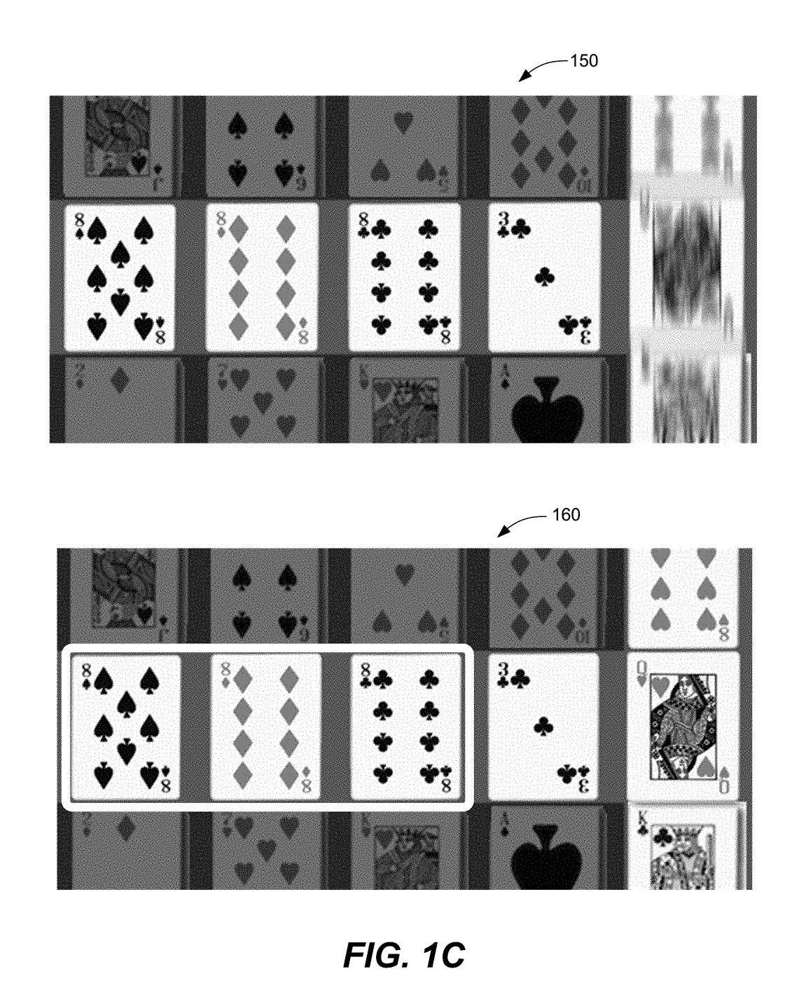

Methods and systems for implementing and executing a video poker game on a gaming machine or gaming device are described in the various figures. FIG. 1 shows how a hand of five cards may be drawn for and displayed to a player. In conventional video poker, the user sees all five cards drawn and shown at once, as shown at the top of FIG. 1. In one embodiment of the present invention, the underlying software of the video poker game enables a different user interface and experience. Each interval or step in one game or hand is shown and briefly described in FIG. 1. A random number generator (RNG) draws the five cards at the top. Once the cards are selected, the software causes a display of the cards. The algorithm shuffles or selects the order that the 5 cards will be displayed to the user. In one embodiment, it is showing the illusion of spinning wheels at 100. At 110 one card is displayed by having the first reel “stop” at the first of the 5 cards. The order of the 5 random cards is determined by the software. This software is described in figures below. At 130 the second card as selected by the algorithm is displayed, again by having the reel “stop” at that card. At 140 the same operation is executed and the third card is displayed. At 150 and 160, the last two cards are shown. The timing of the reel stops and audio is determined by the software and can differ between each card display. Software modules for displaying this user experience and others described below may reside on the gaming machine, gaming device, multiple servers, or mobile devices.

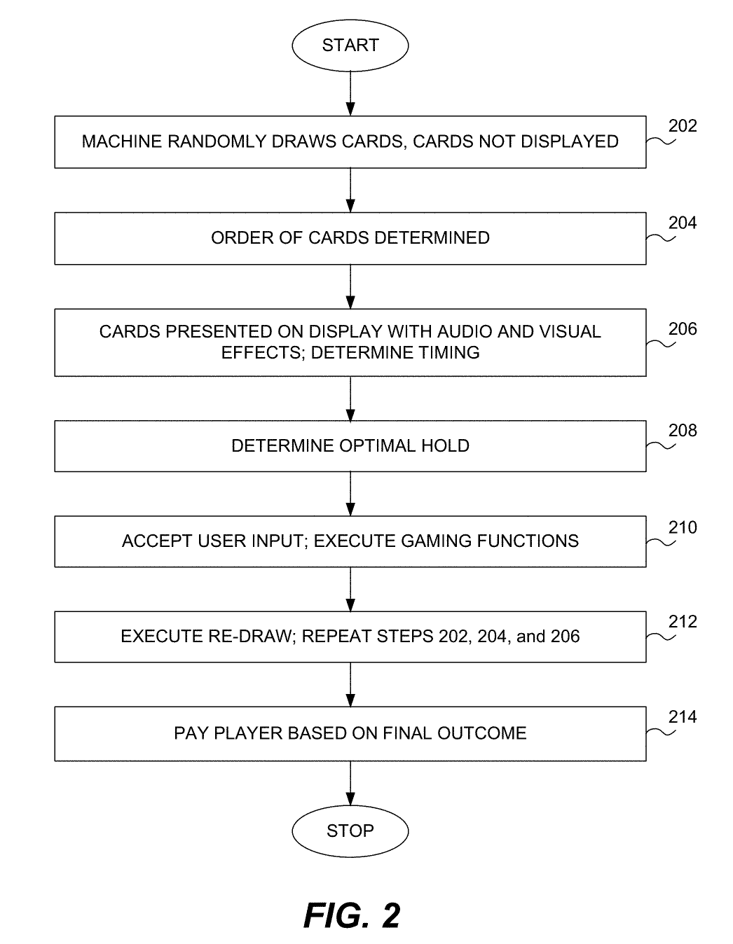

FIG. 2 is a flow diagram of a process of executing a video poker gamer in accordance with one embodiment. Before the process described in FIG. 2 begins, a player takes conventional steps when playing a video poker game; she picks the type of poker game and places a bet. The player then presses, for example, a DRAW button or otherwise causes the machine to draw cards, typically 5, but the number can vary depending on the type of poker game.

At step 202, as is conventionally done, the software executing on the gaming machine randomly draws five cards from a standard deck. The cards are not displayed or shown to the user on the machine. At step 204 an algorithm determines one or more orders or arrangement of the drawn cards. The machine selects one order of cards. There may be several possible variations on how to present the most exciting hand. In one embodiment, the software utilizes a weight table and algorithm, or a combination of both to determine the best possible hands from the five randomly drawn cards. Another factor that may be used to select an order of the cards is the potential payouts based on the pay tables. The cards are still not displayed at step 204 but an order of the cards has been determined.

At step 206 the software begins a display process of the cards on the gaming machine. The presentation has a visual aspect, but may also have an audio aspect, both of which may have a temporal component. In one embodiment, the cards are displayed one at a time. For example, the cards can be faces (or symbols) on electronic spinning reels where each of the five cards is displayed, one card on each reel. Each dealt card is the final “stop” position on each reel. In other embodiments, other types of visual and audio designs may be used, all with the goal of increasing excitement for the user playing the game. As noted, the order in which the cards are displayed is determined at step 204.

The timing between each card being displayed or revealed (e.g., each reel stopping) may be determined by the software. The timing between each card reveal can differ and be tuned or adjusted to increase excitement in the game. For example, the timing between the possibility of two of a kind or three of kind is revealed in the initial three dealt cards, then a greater time interval and different audio track can be used to reveal the fourth dealt card and yet another different time and audio component can be used to reveal the fifth card. For example, a slow peek at the next card to be revealed could be accompanied by an audio effect to add excitement and anticipation. In another example, the audio track for revealing the fourth and fifth cards can be a drumroll or other audio track that punctuates a potential big winning hand. The time intervals between the reveal or display of each card can each be different and the audio can also vary depending on the card to be revealed. In the described embodiment, the time interval between the reveal of the first and second card and the second and third card may be the same. After these first two time intervals, the time intervals may get longer depending on the hand in order to increase player anticipation and excitement.

In one embodiment or version of the game, the game may end at step 206. That is, the player does not have the option of holding any cards. If there is a winning hand from the initial draw the player wins and gets a payout. In another embodiment, the machine determines which cards to hold. This is done at step 208. The software determines the best cards to hold, if any. In another embodiment, at step 210, the machine accepts input from the player.

For example, the machine can automatically hold certain cards as determined at step 208, but the player can override the held cards by the machine and she can select which cards to hold essentially overriding the gaming machine. It can also accept types of other player inputs, for example, additional bets from the player in a variation of the invention that allows the player a second chance to draw cards to achieve certain winning hands.

At step 212 the software may accept input from the player. The re-drawn cards are selected randomly from the remaining cards of the deck and steps 202, 204, and 206 are executed again with the remaining cards from the deck. The cards are not displayed to the player immediately. The re-drawn cards may be presented to the player in a manner similar to the initial draw, using the same visual, audio, and temporal components, all with the goal of increasing excitement of the game. If the re-drawn cards cause a winning hand, the software can implement a greater time delay and different audio when displaying the cards.

At step 214 the machine determines if the final outcome was a winning hand for the player and determines the amount to be paid or credited to the player using a pay table.

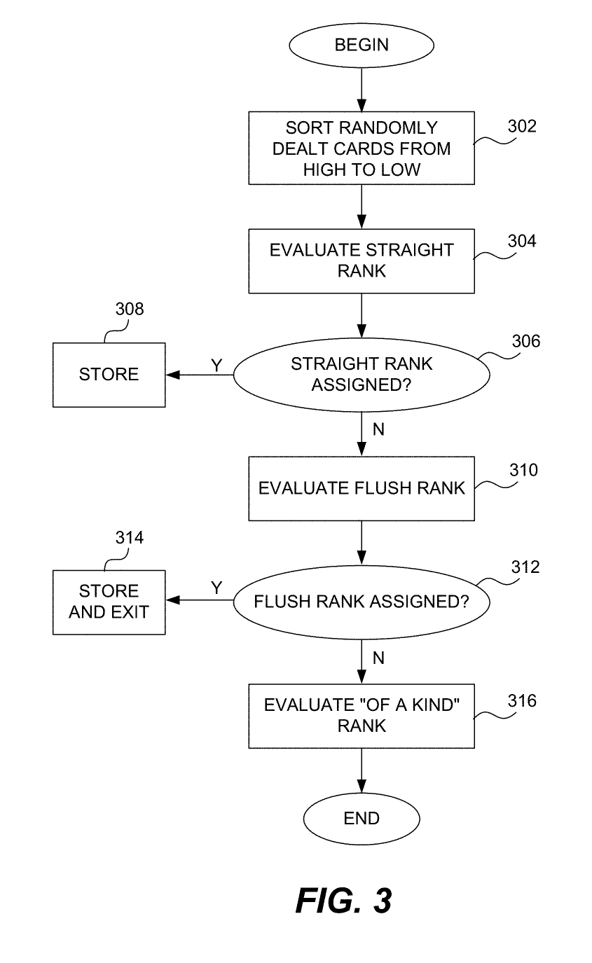

FIG. 3 is a flow diagram showing an overview of a process for evaluating a hand of cards and assigning a rank to the hand for presentation to a user on a gaming device in accordance with one embodiment. At step 302 randomly dealt cards to a player are sorted from high card to low card (i.e., from A to 2). In the described embodiment, the game is 5-card draw poker and the cards are dealt using conventional means such as a random number generator. In other embodiments, the type of poker game can vary and the number of cards dealt can vary (e.g., 3 card poker, 6 card poker, etc.). The cards may also be sorted from low to high card (e.g., from 2 to A). Suits are ignored at this stage.

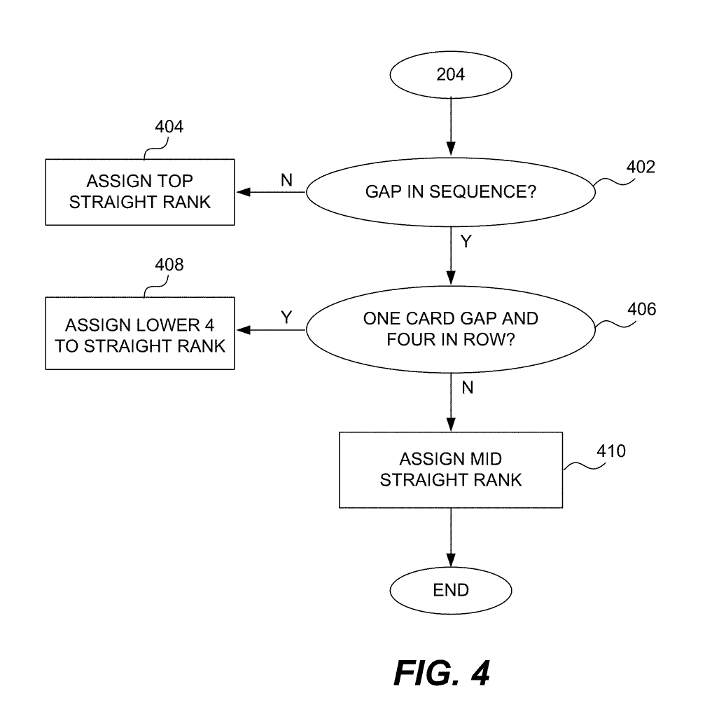

At step 304 software evaluates the sorted hand for a straight. At step 306 the system determines whether a straight rank has been assigned to the hand. A process for how this is done is described in FIG. 4. If a straight hand rank has been assigned, this ranking is stored at step 308, the cards are re-sorted accordingly, and the evaluation process is complete. The presentation stage begins as described below. If the hand has not been assigned a straight rank, control goes to step 310 where the hand is evaluated for a flush ranking.

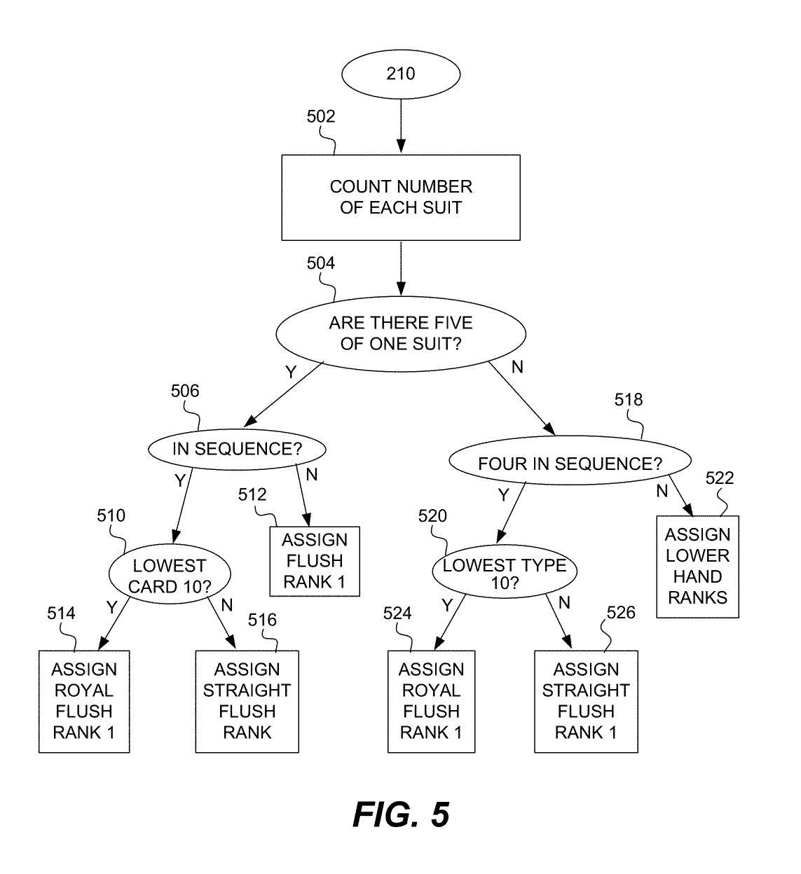

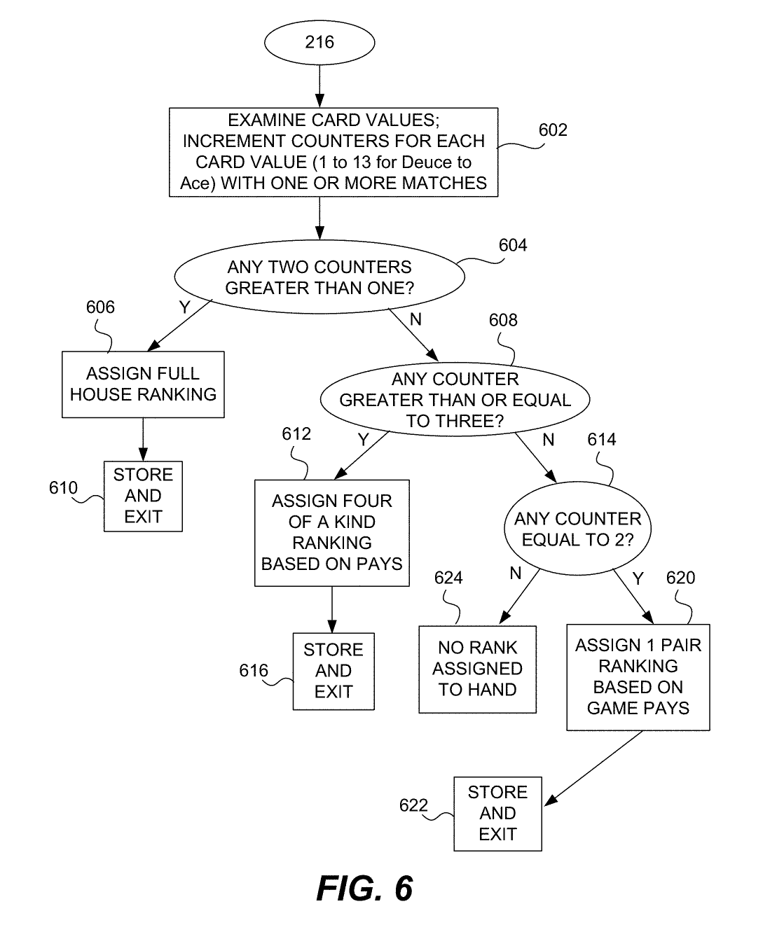

This process is described in more detail in FIG. 5. At step 312 the software determines whether a flush ranking has been assigned and if one has, control goes to step 314 where the ranking is stored and the presentation stage begins. If one has not been assigned, control goes to step 316. Here the software evaluates the hand for an “of a kind” ranking. These hands include four of a kind, full house, three of a kind, two pair, and one pair. This is described in FIG. 6. In other embodiments, a flush ranking may be evaluated before a straight ranking.

FIG. 4 is a flow diagram of a process for evaluating a hand for a straight and assigning it a straight ranking in accordance with one embodiment. It describes step 306 from FIG. 3. At step 402 the software examines the sorted hand and determines whether there are any gaps in the sequence of cards. If there are none, it means the hand is a straight and control goes to step 404 where the hand is assigned a straight rank 1, essentially the top rank straight. If there is a gap in the sequence, control goes to step 406 where the system determines if there is only one gap and if the other cards comprise a sequence of four. If this is the case, control goes to step 408 where the hand is assigned a straight rank 2 (or a lower 4 to straight rank). In this case an outside straight is possible. If there is not a one card gap and not four in a row, control goes to step 410 where a straight rank 3 is assigned, where an inside straight is possible.

FIG. 5 is a flow diagram of a process of assigning various flush rankings, including royal flush, straight flush rankings, and lower rank flushes to a hand in accordance with one embodiment. At step 502 the software counts the number of each suit in the hand. That is, it counts how many clubs, hearts, spades, and diamonds there are in the hand. At step 504 it determines if all five cards are of the same suit; that is, if any suit has a count of 5. If so, control goes to step 506. Here the software also determines if the cards are in sequence. It can do this by checking if the hand has been assigned a straight rank 1. If it has, control goes to step 510 where the system checks whether the lowest card in the sequence is a 10. If it is, the hand is assigned a royal flush rank 1 at step 514. If the lowest card in the sequence is not 10, the hand is assigned a straight flush rank 1 at step 516.

If it is determined at step 504 that the cards are not all the same suit, control goes to step 518. Here the software checks whether there are four cards in sequence. If true, control goes to step 520 where the software determines if the lowest card is a 10. If the lowest card is 10, control goes to step 524 where the hand even though not a royal flush, a rank of royal flush rank 1 is assigned. It is important to note here that hand rankings are not necessarily unique to only one hand. In the present invention, the rankings are used for determining presentation of the cards to a user, that is, configuring the user experience to the user. One example is timing of when certain cards are revealed. As such, an actual royal flush hand has the same ranking as a four to a royal flush, which also is assigned a royal flush ranking 1, as shown in step 524. Similarly, if the lowest card is not 10, control goes to step 526 where the hand is assigned of straight flush rank 1, as was done in step 516, where the hand was determined to be an actual straight flush. In the described embodiment, for card presentation purposes, the hand rankings are the same.

At step 518, if it is determined that there are not four in sequence, control goes to step 522 where the hand is assigned a lower hand rank. In one embodiment, these lower rank hands include royal flush rank 2 (3 to a royal flush), straight flush rank 2 (4 to a flush), flush rank 2 (3 to flush), royal flush rank 3 (2 to a royal flush), and others.

In one embodiment, 35 poker hands are ranked in the order as shown here using standard card notation: kRoyalFlush5, kSt8Flush5, kRoyalFlush4, kSt8Flush4, k4Aces234, k4of234plusA234, k4Aces, k4JPlus, k4Royals, k4Eights, k4Sevens, k4of234, k4ofAKind, kFullHouse, kFlush5, kSt8to5, k3Aces, k3Royals, k3JPlus, k3Eights, k3Sevens, k3ofAKind, kRoyalFlush3, kSt8Flush3, k2Pair, kFlush4, kSt8to4, kRoyalFlush2, kPairJPlus, kPairRoyal, kPair8Plus, kPair7Plus, kPair, kFlush3, kSt8to3. Each hand rank has a unique index or identifier. However, a lower index number does not necessarily imply a higher ranked poker hand. As described above, hand ranking may depend on other factors, such as the pay table for a specific game. In one example, a k3Sevens may rank higher than a k3JPlus for a 7s or better pay table game.

FIG. 6 is a flow diagram of a process of assigning ranks to a hand that is not a straight, flush, or combination. These hands are referred to as “of a kind” hands and include, but are not limited to, full house, two pair, and 4, 3, and 2 of a kind (2 of a kind being a pair). At step 602 the software examines each card type and maintains a counter for each type, using 13 counters (2 to Ace). Each time a card type is examined, one of the 13 counters is incremented by one. In one embodiment, card suits are not examined at this stage. For example, if a hand is K, 9, 6, 6, and 4, the counter for Kings is 1, the counter for 9 is 1, the counter for 6 is 2, and the counter for 4 is 1. Thus, if a hand has two pairs, there will be two counters that have a value of 2. If a hand is a full house, there will be two counters that will have a value of 2 or greater, specifically, one will have a counter value of 2 and another will have a counter value of 3. The other counters will all be zero or null. In one embodiment, the counters may be implemented as a 13 cell, 2-dimensional array (an “of a kind” array).

At step 604 the software determines whether any two counters have a value greater than 1 (i.e., is 2 or more). If so, the hand has either two pair or a full house. For presentation purposes, in one embodiment, these two hand types are treated the same and given the same ranking. At step 606, the hand is given a full house ranking. This is stored and the system proceeds to the presentation stage. If there are not any two counters that have values greater than 1, control goes to step 608 where the system checks whether there is any one counter that has a value that is greater than or equal to 3. If so, the hand has at least a three of a kind or a four of a kind. At step 612 the hand is assigned a four of a kind ranking. Various levels of four of a kind rankings may be used based on different game pay tables for different kinds of four of kinds and three of a kinds. For example, four deuces may pay more than four 7s and therefore may have a higher four of a kind ranking.

If none of the counters has a value of three or more, as determined at step 608, control goes to step 614. Here the system checks whether one of the counters has a value of 2 and the rest have only 1s or 0s. If there is one counter with a value of 2, control goes to step 620 and the hand is assigned a 1 pair ranking. Similarly, this ranking may have various levels based on various types of games with different pay tables. For example, there may be custom 3 of a kind pays which may be three of certain types plus a kicker or a special card. There may also be custom 4 of kind hands such as four Aces, 2, 3, or 4s which pay more than other 4 of kinds. The custom 4 of kinds may be given a higher four of a kind ranking than the regular 4 of a kind hands.

In other embodiments, hand rankings may be determined using different rules based on various games. The rankings may also be different if the poker game uses fewer or more than five cards. However, the general rules of poker hands are used to determine the hand rankings. As described, game pay tables and special games are also factors in determining hand rankings. Of course, there are many variations of video poker, whether played on a gaming machine, a gaming device, a mobile device, a general purpose computer, over a network, or on the Internet, which can lead to a large number of possible hands. The guidelines provided in the flow diagrams above may be used to assign ranks and sub-ranks to hands. These rankings are used to determine the timing of the presentation (or display) of individual cards in a hand.

In one embodiment, the software causes the presentation to the player of each of the randomly drawn cards using one of multiple time intervals. The cards are initially sorted from low to high as described. When the hand has been assigned a rank, it is stored in an order corresponding to the hand. In one example, a four of a kind ranking have the three or four cards first.

The software for implementing the various functions described above may reside on a gaming machine, a gaming network, a mobile gaming device, or on a computing device that is connected to gaming servers over the Internet. There are various functional software modules that perform the following: straight hand evaluations, flush hand evaluations, of-a-kind hand evaluations, and user experience/user interface modules. These modules are executed by a processor to perform the functions in FIGS. 2 to 6.

The memory components store the data needed for carrying out the functions, such as an of-a-kind array, an array for storing matches, and counters for card type and suit. The memory is also used to store the hand rankings and card arrangements, as well as any other data needed by the system to execute the presentation of the cards to the player. The UX/UI modules may implement various types of screen displays, such as the spinning reel interface and others, all with the objective of increasing player excitement.

The time intervals taken between revealing each card in a hand may be determined by time interval software modules which execute in conjunction with the UX/UI modules and causes the cards to be revealed to the player at the correct time intervals, i.e., delays. There may also be software modules for re-arranging the presentation of the cards before they are revealed to the player, such as the order of the cards to be displayed on virtual spinning reels in a video slot machine type user interface. Examples of such presentations are described below.

Below is a general description of various embodiments, examples, alternative embodiments and variations of the present invention. Shown are several variations of basic video poker that improve the entertainment value (or “fun factor”) and excitement for players by allowing a machine or algorithm to adjust the order of the cards shown and revealed to maximize excitement by emphasizing the chance of big winning hands.

Some variations of this invention place the cards on virtual reel strips to create an experience similar to a slot machine. Some variations also help simplify the game for players by automatically holding cards and grouping them in a way that represents a winning hand. Additional variations eliminate some elements of video poker, such as held cards and re-draws, offering much higher pays and more rapid game play. A key feature is the order of the cards shown and revealed (e.g., reels spun and stopped) which are determined by a machine.

In one embodiment 5 cards are drawn by a machine as in basic video poker. The cards are then arranged on 5 distinct reels like a slot machine. Each reel has 10 cards. One additional card is added to the 4th and 5th reels. The final stop position of each reel is 1 of the 5 cards randomly drawn. The reels are spun like a slot machine. The order of the cards shown and revealed (or reels spun and stopped) are determined by a machine, whereas video poker currently randomly determines the order and instantly presents all of the cards.

A machine determines the best possible winning hand from the initial draw to determine the order in which the cards are presented. The player is paid based on the only and final outcome (machine holds cards). In another embodiment a video poker game in which players are paid based on the cards dealt after an initial draw. The player is not allowed to hold and discard any of the cards in the hand. The pay outs for each hand are much higher and the pace of play is much faster since no redraw is offered. In this example and in the examples, variations, and embodiments described below, the order of the cards shown and the timing of how they are revealed (e.g., reels spun and stopped) are determined by software executing on one or more computing devices.

In another embodiment, players draw cards with a delay (e.g., drumroll) and the software may show the player a peek of the card before it is revealed. The key feature would remain: the order of the cards shown and revealed (e.g., reels spun and stopped) is determined by the software.

As noted, the software can be used to determine the best possible hand based on the pay outs or pay table for a particular video poker variation or game. For example, in a bonus poker type game, 2 or more Aces (which pay higher in this variation of video poker) would have more weight which means they would be presented to the player first and a longer spin or delay could be used before presenting the next card. The order of the cards shown and the timing of how they are revealed (e.g., reels spun and stopped) are determined by software executing on one or more computing devices.

In one example, player draws Q/8/K/9/J. The remaining undrawn cards are randomly added to each reel strip. The reels are arranged according to the highest possible paying hand. In this case the player has 4 cards to an inside straight. The software arranges the cards and stops the reels in the following order: K/Q/J/9. In addition, the software can use a longer spin to add excitement. For example, after the 3rd reel stops, the player has 3 cards to an outside straight. A longer spin on the 4th reel will give the player excitement in anticipation of receiving a 4th card to a straight (an Ace or a 10). After the 4th reel stops showing a 9, the player still has a chance for a straight. In this case, the player needs a 10 to make a straight. In addition, the reels can be dynamically re-arranged to make it easier for the player to understand which card is needed for a straight. The 4th reel can be swapped with the 5th reel. In this case, the reels would be in the order K/Q/J/?/9 where ? is the reel that is still spinning. In a virtual slot reels presentation of this example, cards with 10 may be highlighted on the reel that is spinning to make it easier for the player to see which card is needed for a straight.

In another example, player draws 8/K/8/2/8. The player has 3 of a kind with a chance for 4 of a kind. The reels are arranged to stop in the order 8/8/8/K/2. After the initial 3 of a kind, a long spin can be used for the 4th reel to add excitement. The remaining 8 can be highlighted if it is on the 4th reel. For example, a long spin can be used on the 5th reel and the remaining 8 or any Ks (that would make a full house) on the 5th reel can be highlighted.

In another example, the player draws 3/K/3/K/7. The game is Triple Double Bonus where 4 of kind 2s, 3s and 4s pay more than most other 4 of a kinds. The player has 2 of a kind 3s. In this example, cards are used instead of slot reels for the presentation. The cards are arranged to be dealt and revealed in the order 3/3/K/K/7. After the initial 2 of a kind is revealed, a drumroll and slow peek of the card can be used to show the 3rd and 4th cards: both Ks. Finally, a longer delay can be used to reveal the 5th card since the player can win a full house with a K or a 3.

The player has 3 of a kind with a chance for 4 of a kind. The reels are arranged to stop in the order 8/8/8/K/2. After all the reels have completed spinning, the machine holds the cards 8/8/8 and spins the remaining reels again. The player is dealt 2 random cards. The remaining 47 cards in the deck are randomly divided between reels 4 and 5. A longer and/or slower spin can be used to increase excitement. The remaining 8 in the deck can be highlighted to add excitement and make it easy for the player to see the card they are hoping for.

In another example, a user overrides cards held by the software. Player draws Qc/Ah/Jc/9c/10c (where c is clubs and h is hearts). The player has a chance for an outside straight or a Royal Flush. The machine chooses to hold the cards: Qc/Jc/10c/9c because on average it offers a higher return for the player according to the particular pay table for this variation of video poker. The player wants to go for a Royal Flush instead and chooses to hold the cards Qc/Jc/10c and discard the cards Ah and 9c. The machine randomly draws 2 cards and places them at the final stop position for reels 4 and 5. The remaining 47 cards in the deck are divided between reels 4 and 5. The 4th and 5th reel are spun in an order to provide the most excitement for the player. For example, the 4th and 5th cards are 2h and Ac. The 4th reel shows the Ac and a long, slow spin is used for the 5th reel.

The player has 3 of a kind with a chance for 4 of a kind. The reels are arranged to stop in the order 8/8/8/K/2. After all the reels have completed spinning, the player has a chance to hold any number of cards. If the player holds the 1st 3 cards, the remaining 49 cards in the deck are divided between reels 4 and 5. A longer and/or slower spin can be used to increase excitement. The remaining 8 can be highlighted to add excitement and make it easy for the player to understand what cards can lead to a big win.

In this alternative embodiment of embodiments described above, the player is dealt 6 cards. The cards are divided into 6 reels. This gives the player a greater probability of making big hands. The pay table would need to be reduced or the bet requirement increased to account for the improved odds of making big hands. The order of the cards shown and revealed (or reels spun and stopped) are determined by a machine.

In this alternative embodiment of embodiments described above, the player is dealt 7 cards. The cards are divided into 7 reels. This gives the player a greater probability of making big hands. The pay table would need to be reduced or the bet requirement increased to account for the improved odds of making big hands. The order of the cards shown and revealed (or reels spun and stopped) are determined by a machine.

In one embodiment, the card suits can be shown by a backlight where the blacklight light is projected onto a reel strip and a special material is used to only be revealed when under a particular backlight or an LCD overlay in front of the reel strips projects the card suits onto the reels.

In one embodiment the player has one opportunity to discard any number of unwanted cards (1-5) and is dealt an equal number of replacement cards from the same deck and the machine determines the order of the reels (or cards) and the order and timing of when they are stopped (or revealed) based on the winning possibilities of the cards dealt and held in order to maximize excitement for the player.

This is a variation of the embodiments described above in which a weight table is used to determine the probability of which cards are drawn for a video version of the games. This could be used to effectively lower or raise the pay out of the game. Regulators would likely require disclosure of this modification. The key factor is that the order of the cards shown and revealed (e.g., reels spun and stopped) is determined by software executing on a machine.

In another embodiment of single draw video poker, the player is given re-spins for a second (or more) chance to win when she comes close to making a big hand. For example, four to a royal flush. The pay table may be reduced slightly to account for the extra spin(s).

In another embodiment of single draw or redraw video poker, the player is given the opportunity to make an additional bet for another chance to make a hand. The bet amount may be determined by the potential pay out and odds of making the hand they are trying for. For example, if the player achieved four cards to a royal flush, the odds of making the hand are low but the payout is very large so the bet required may be determined by the average return. Alternatively, an extra bet may be added on each play with the amount of the bet determined by the average added value of the second chance. The hands in which the player could “buy a second chance” may limited by the machine to maintain a sufficient pace of play or unlimited.

In another embodiment, 5 cards are drawn by the gaming machine, more specifically, the random number generator, as in basic video poker. The cards are arranged on 5 distinct reels like a slot machine. Each reel has 10 cards. One additional card is added to the 4th and 5th reels. The final stop position of each reel is 1 of the 5 randomly drawn cards. The reels appear to be spinning as in a slot machine. The order of when the reels are stopped is determined by a machine in an intelligent manner according to which hands are potentially ranked higher. For example, if the player has drawn the cards K/8/8/2/8, the 2nd, 3rd, 5th, 1st and 4th reels, respectively, are stopped in that order. A long spin (time interval) is used before stopping the 5th reel. An even longer spin (longer time interval) is used before stopping the 1st reel and a longer, slow spin is used before stopping the 4th reel. The key feature would remain: the order of the cards shown and revealed (e.g., reels spun and stopped) is determined by the software.

In another embodiment, 5 cards are drawn by a machine as in basic video poker. The cards are then revealed in an order and according to timing that is determined by a machine in an intelligent manner according to which hands are potentially ranked higher. For example, if the player has drawn the cards K/8/8/2/8, the 2nd, 3rd, 5th, 1st and 4th cards from the left, respectively, are revealed in that order. A delay is used before showing the card in the 5th position from the left. An even longer delay is used before showing the 1st card from the left and a longer delay (and in one example a slow peek of the last card) is used before showing the 4th card from the left. The key feature would remain: the order of the cards shown and revealed (e.g., reels spun and stopped) is determined by the software.

In another embodiment, 5 cards are drawn by a machine as in basic video poker. The cards are dealt as shuffled as in standard video poker. In addition to the dealt hand, there are 4 additional hands displayed to the player. It could be 3, 5, 10 or any multiple number of hands displayed. This is known in the art as multi hand video poker. The player is dealt the cards: K/7/8/2/8. The player holds the two 8s. The player is dealt 3 cards for each of 5 hands (in this example) with the two held 8s. The cards are then revealed in an order and according to timing that is determined by a machine in an intelligent manner according to which hands are potentially ranked higher. In this example, the payer receives three 8s on one of the 5 dealt hands. The machine determines that this is the most exciting hand to show the player so it highlights this hand. The machine arranges the hand to show the player three 8s starting from the left. A delay is used before showing the 4th card. A longer delay is used before showing the 5th card. The key feature would remain: the order of the cards shown and revealed (e.g., reels spun and stopped) is determined by the software.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method of displaying cards on a gaming machine comprising:
determining straight hand rankings by detecting if there is a gap in an ordered hand;
determining flush hand rankings by examining the suit of each card in the hand; and
determining of a kind hand rankings by counting the number of each card type in the hand, wherein a hand is assigned a ranking as a flush ranking, a straight ranking, or an of-a-kind ranking.

2. A method as recited in claim 1 wherein determining of-a-kind hand rankings further comprises:
determining whether the hand is one of a full house or two pair.

3. A method as recited in claim 1 wherein determining of-a-kind further comprises:
determining whether the hand is one of a pair, three of a kind, or four of a kind.

4. A method as recited in claim 1 wherein determining flush hand rankings further comprises:
assigning a flush rank if all cards in the hand are of the same suit and the lowest type of card in hand is not a 10;
assigning a straight flush rank if all cards in the hand are in sequence, of the same suit, and the lowest type is not a 10; and
assigning a royal flush ranking if all cards in the hand are in sequence, of the same suit, and the lowest type is a 10.

5. A method as recited in claim 2 further comprising:
counting a first number of each type of card in the hand, each type having a count of 0, 1, 2, 3, 4, or 5;
counting a second number of each type of card where the first number is 2 or greater; and
assigning the hand rank of full house or two pair if the second number is greater than 1.

6. A method as recited in claim 1 wherein determining flush hand rankings further comprises:
assigning a “flush four” rank if the hand is four-to-a-straight flush or four-to-a-flush; and
assigning a “flush three” rank if the hand is three to a straight flush or three-to-a-flush.

7. A method as recited in claim 1 wherein determining straight hand rankings further comprises:
assigning a mid-rank straight if there is one-card gap in the hand sequence and assigning a low-rank straight if there are only 3 cards in sequence.

8. A method of presenting five cards in a video poker game comprising:
displaying a first card after a first time interval;
displaying a second card after the first time interval;
displaying a third card after a second time interval;
displaying a fourth card after a third time interval; and
displaying a fifth card after a fourth time interval, wherein the second time interval is longer than the first interval, the third time interval is equal to or longer than the second interval, and fourth interval is equal to or longer than the third interval, and wherein the time intervals are determined by a hand ranking of the five cards and one or more pay tables corresponding to one or more poker games.

9. A method as recited in claim 8 further comprising:
determining if there are four cards to a royal flush and displaying said cards first;
determining if there are three cards to a royal flush and displaying said three cards first; and
determining if there are two cards to a royal flush and displaying said two cards first.

10. A method as recited in claim 8 further comprising:
determining if there are four cards to a flush and displaying said four cards in order second; and
determining if there are four cards to a straight and displaying said four cards in sequential order second.

11. A method as recited in claim 8 further comprising:
determining if there are three or more cards to a flush and displaying said cards in sequential order.

12. A method as recited in claim 8 further comprising:
determining if there are four cards of the same type and randomly determining whether to display three or four of said cards first.

13. A method as recited in claim 8 further comprising:
determining if there are three cards of the same type and displaying said three cards first.

14. A method as recited in claim 8 further comprising:
determining if there are two cards of the same rank and displaying said cards first; and
determining if there are two more cards of the same rank and displaying said cards in sequential order second.

15. A gaming device comprising:
one or more processors for executing
a straight hand evaluator module for detecting if there is a gap in an ordered hand and assigning a straight hand ranking if needed;
a flush hand evaluator module for examining the suit of each card in the hand and assigning a flush hand ranking if needed; and
an of-a-kind hand evaluator module for counting a number of each card type in the hand and assigning an of-a-kind ranking if needed;
a memory for storing an of-a-kind array and a plurality of counters; and
a display for presenting cards to a player.

16. A gaming device as recited in claim 15 further comprising a user interface module for implementing a virtual slot reel interface for displaying cards in the hand.

17. A gaming device as recited in claim 15 further comprising a time interval module for determining a plurality of time intervals used for displaying cards to the player wherein a time interval determines how the cards will be presented.

18. A gaming device as recited in claim 15 wherein the of-a-kind array stores a count of each type of card in the hand.

19. A gaming device as recited in claim 15 wherein said counters store a first count of each type of card in a hand wherein each type has a count of 0, 1, 2, 3, 4, or 5 and a second count of each type of card where the first count is 2 or greater.

20. A gaming device as recited in claim 15 wherein the memory stores pay tables which are used to determine hand rankings.
